(19) United States
(12) Patent Application Publication
(10) Pub. No.: US 2010/0235821 A1
(43) Pub. Date: Sep. 16, 2010

(54) STORING AND LOADING SERVER-SIDE APPLICATION EXTENSIONS IN A CLUSTER ENVIRONMENT

(76) Inventors: TIMOTHY JOHN BALDWIN, Southampton (GB); Ian Mark Shore, Eastleigh (GB)

Correspondence Address: Dillon & Yudell LLP, 8911 N. Capital of Texas Hwy, Suite 2110, Austin, TX, 78759, US

(21) Appl. No.: 12/196,993

(22) Filed: Aug. 22, 2008

(51) Int. Cl. G06F 9/44

(52) U.S. Cl. 717/166

(57) ABSTRACT

A method, system and computer program product for enabling a class loader of a Java virtual machine to load JAVA class and resource data from within a registry/repository application. The JAVA class and resource data is loaded from within a registry/repository application that includes a database which stores one or more JAR files; whereby, the JAR files contain a user-written plug-in code and resources. The user-written plug-in code and resources are dynamically modified when modifications to one or more stored JAR files are received. The JAR files are rebuilt in a location outside of the registry/repository development environment.

### BACKGROUND

1. Technical Field

The present invention generally relates to computer systems and in particular to a cluster environment in computer systems.

2. Description of the Related Art

A Java 2 platform enterprise edition (J2EE) application, which implements a registry or repository function, is typically executed in a cluster environment. In the cluster environment there is one database; however, in many instances the J2EE application is executing on multiple nodes within the cluster. One or more problems may arise when the J2EE application supports user-exit or plug-in code extensions at various points of processing. For example, there is one problem in how Java classes which implement user-written extensions are accessed, as well as another problem in how the user written extensions access complied-in resources. An additional problem includes how the user written extensions are made available to each instance of the application on each node in the cluster.

In a J2EE application, the user-written plug-in code and the user-written plug-in code's associated complied-in resources are a number of Java classes typically bundled together in one or more Java archives (JAR) files. A typical solution to the problem of implementing JAR files in multiple nodes is to configure each node in the cluster so that these JAR files appear on the Java class-path of each J2EE application instance. Unfortunately, utilizing the typical method of implementing JAR files in multiple nodes requires configuration of multiple systems. A potentially worse problem with the typical solution is that multiple systems must be reconfigured if the user-written plug-in code is changed.

### SUMMARY OF ILLUSTRATIVE EMBODIMENTS

Disclosed are a method, system and computer program product for enabling a class loader of a Java virtual machine to load JAVA class and resource data from within a registry/repository application. The JAVA class and resource data are loaded from within a registry/repository application that includes a database which stores one or more JAR files; whereby, the JAR files contain a user-written plug-in code and resources. JAVA classes and resource data are created from raw-byte streams, and the raw-byte streams represent compiled source code. When a Java class is loaded and requires another Java class, the Java virtual machine can additionally search the JAR files within the registry/repository. The search of the JAR files is conducted by retrieving the raw bytes from the database, wherein the one or more raw bytes represent JAVA classes and associated resources. User-code extensions may be invoked when the repository application retrieves the compiled source code from the JAR files. The user-written plug-in code is dynamically modified when modifications to one or more stored JAR files are received. The JAR files are rebuilt in a location outside of the registry/repository development environment. In response to the modifications of the user-written plug-in code, one or more of the following are completed within the registry/repository: (1) code is added to the JAR files; (2) code is changed within the JAR files; and (3) code is deleted from within the JAR files. The modified JAR files are then automatically made available to nodes executing within the JAVA cluster environment.

The above as well as additional features of the present invention will become apparent in the following detailed written description.

### BRIEF DESCRIPTION OF THE DRAWINGS

The invention itself will best be understood by reference to the following detailed description of an illustrative embodiment when read in conjunction with the accompanying drawings, wherein:

FIG. 1 is a block diagram of a data processing system, within which various features of the invention may advantageously be implemented according to one embodiment of the invention;

FIG. 2 illustrates a block diagram of a Java virtual machine in accordance with one embodiment of the invention;

FIG. 3 is a diagram of a Java cluster environment according to one embodiment of the invention;

FIG. 4 is a logic flow chart illustrating a method for modifying user-written plug-in code when modifications to the JAR files are received in accordance with one embodiment of the invention; and

FIG. 5 is a logic flow chart illustrating a method for allocating the availability of the modified JAR files to nodes within the JAVA cluster environment according to one embodiment of the invention.

### DETAILED DESCRIPTION OF AN ILLUSTRATIVE EMBODIMENT

The illustrative embodiments provide a method, system and computer program product for enabling a class loader of a Java virtual machine to load JAVA class and resource data from within a registry/repository application. The JAVA class and resource data is loaded from within a registry/repository application that includes a database which stores one or more JAR files; whereby, the JAR files contain a user-written plug-in code and resources. JAVA classes and resource data are created from raw-byte streams, and the raw-byte streams represent compiled source code. When a Java class is loaded and requires another Java class, the Java virtual machine can additionally search the JAR files within the registry/repository. The search of the JAR files is conducted by retrieving the raw bytes from the database, wherein the one or more raw bytes represent JAVA classes and associated resources. User-code extensions may be invoked when the repository application retrieves the compiled source code from the JAR files. The user-written plug-in code is dynamically modified when modifications to one or more stored JAR files are received. The JAR files are rebuilt in a location outside of the registry/repository development environment. In response to the modifications of the user-written plug-in code, one or more of the following are completed within the registry/repository: (1) code is added to the JAR files; (2) code is changed within the JAR files; and (3) code is deleted from within the JAR files. The modified JAR files are then automatically made available to nodes executing within the JAVA cluster environment.

In the following detailed description of exemplary embodiments of the invention, specific exemplary embodiments in which the invention may be practiced are described in sufficient detail to enable those skilled in the art to practice the invention, and it is to be understood that other embodiments may be utilized and that logical, architectural, programmatic, mechanical, electrical and other changes may be made without departing from the spirit or scope of the present invention. The following detailed description is, therefore, not to be taken in a limiting sense, and the scope of the present invention is defined only by the appended claims.

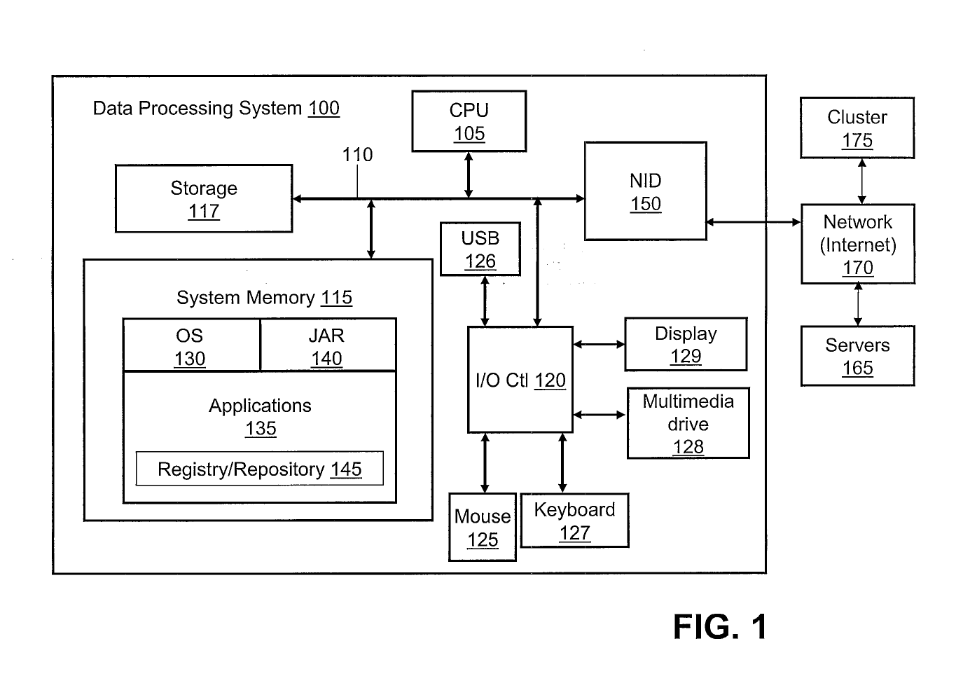

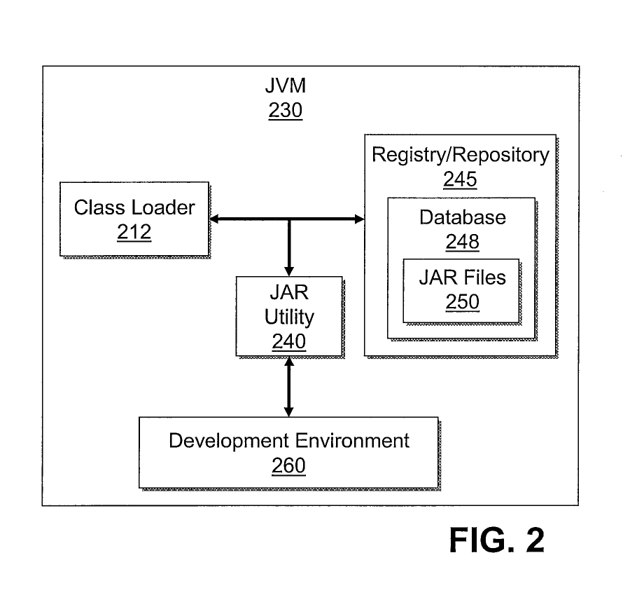

Within the descriptions of the figures, similar elements are provided similar names and reference numerals as those of the previous figure(s). Where a later figure utilizes the element in a different context or with different functionality, the element is provided a different leading numeral representative of the figure number (e.g., 1xx for FIG. 1 and 2xx for FIG. 2). The specific numerals assigned to the elements are provided solely to aid in the description and not meant to imply any limitations (structural or functional) on the invention.

It is understood that the use of specific component, device and/or parameter names are for example only and not meant to imply any limitations on the invention. The invention may thus be implemented with different nomenclature/terminology utilized to describe the components/devices/parameters herein, without limitation. Each term utilized herein is to be given its broadest interpretation given the context in which that terms is utilized. Specifically, as utilized herein, the term “registry/repository” is a service registry and repository which may be represented herein as simply “registry”, “repository”, or “registry/repository”.

With reference now to the figures, FIG. 1 depicts a block diagram representation of a data processing system (and connected network). Data processing system (DPS) 100 comprises at least one processor or central processing unit (CPU) 105 connected to system memory 115 via system interconnect/bus 110. Also connected to system bus 110 is input/output (I/O) controller 120, which provides connectivity and control for input devices, of which pointing device (or mouse) 125 and keyboard 127 are illustrated, and output devices, of which display 129 is illustrated. Additionally, a multimedia drive 128 (e.g., CDRW or DVD drive) and USB (universal serial bus) port 126 are illustrated, coupled to I/O controller 120. Multimedia drive 128 and USB port 126 may operate as both input and output (storage) mechanisms. DPS 100 also comprises storage 117, within which data/instructions/code may be stored.

DPS 100 is also illustrated with a network interface device (NID) 150, with which DPS 100 connects to one or more servers 165 via an access network, such as the Internet 170. In the described embodiments, Internet 170 is a worldwide collection of networks and gateways that utilize the Transmission Control Protocol/Internet Protocol (TCP/IP) suite of protocols to communicate with one another. Of course, network access may also be provided via a number of different types of networks, such as an intranet, a local area network (LAN), a virtual private network (VPN), or other wide area network (WAN) other than the Internet, for example. NID 150 allows communication with cluster 175, wherein cluster 175 comprises one or more nodes which may be connected via a local area network.

Notably, in addition to the above described hardware components of DPS 100, various features of the invention are completed via software (or firmware) code or logic stored within system memory 115 or other storage (e.g., storage 117) and executed by CPU 105. Thus, illustrated within system memory 115 are a number of software/firmware components, including operating system (OS) 130 (e.g., Microsoft Windows®, a trademark of Microsoft Corp, GNU®/Linux®, registered trademarks of the Free Software Foundation and Linus Torvalds, or AIX®, a registered trademark of IBM), applications 135, including registry/repository application 145, and Java Archive (JAR) utility 140. In actual implementation, applications 135 (including registry/repository application 145) and JAR utility 140 may be combined as a single application collectively providing the various functions of each individual software component when the corresponding code is executed by CPU 105. For simplicity, JAR utility 140 is illustrated and described as a stand alone or separate software/firmware component, which provides specific functions, as described below.

CPU 105 executes JAR utility 140 as well as OS 130, which supports the user interface features of JAR utility 140. In the illustrative embodiment, JAR utility 140 enables user interaction with, or manipulation of, the functional features of the utility (140). Among the software code/instructions provided by JAR utility 140, and which are specific to the invention, are: (a) code for enabling a class loader of a Java virtual machine to load JAVA class and resource data from within a repository application; (b) code for dynamically modifying the user-written plug-in code when modifications to one or more stored JAR files are received; and (c) code for automatically allocating the availability of the modified JAR files to members executing on nodes within the cluster. For simplicity of the description, the collective body of code that enables these various features is referred to herein as JAR utility 140. According to the illustrative embodiment, when CPU 105 executes JAR utility 140, DPS 100 initiates a series of functional processes that enable the above functional features as well as additional features/functionality, which are described below within the description of FIGS. 2-5.

Those of ordinary skill in the art will appreciate that the hardware and basic configuration depicted in FIG. 1 may vary. For example, other devices/components may be used in addition to or in place of the hardware depicted. The depicted example is not meant to imply architectural limitations with respect to the present invention. The data processing system depicted in FIG. 1 may be, for example, an IBM eServer pSeries system, a product of International Business Machines Corporation in Armonk, N.Y., running the Advanced Interactive Executive (AIX) operating system or LINUX operating system.

With reference now to FIG. 2, which illustrates a Java virtual machine (JVM). JVM 230 comprises class loader 212, JAR utility 240, development environment 260, and registry/repository application 245. Within registry/repository application 245 are database 248 and JAR files 250.

In one embodiment, class loader 212 within JVM 230 loads JAVA class and resource data from within registry/repository application 245, when registry/repository application 245 (FIG. 1) includes database 248. Database 248 stores JAR files 250 and JAR files 250 contain user-written plug-in code. Class loader 212 searches JAR files 250 to find raw-bytes that constitute the compiled classes and resources of the user written plug-in code (also known as the source code).

In one embodiment, the JAVA classes, or JAVA class and resource data, are created from the raw-byte streams, wherein the raw-byte streams represent the compiled source code. The JAVA class and resource data is loaded from registry/repository application 245. JAR files 250 are searched by class loader 212 to retrieve the raw bytes of the compiled source code. When changes to JAR files 250 are received, the source code (or user-written plug-in code) is dynamically modified.

In one embodiment, utilizing JAR utility 240, the user-written plug-in code is dynamically modified when modifications to one or more JAR files 250 are received. When the modifications are received for the user-written plug-in code, JAR files 250 are rebuilt in development environment 260 via JAR utility 240, wherein development environment 260 is outside registry/repository application 245.

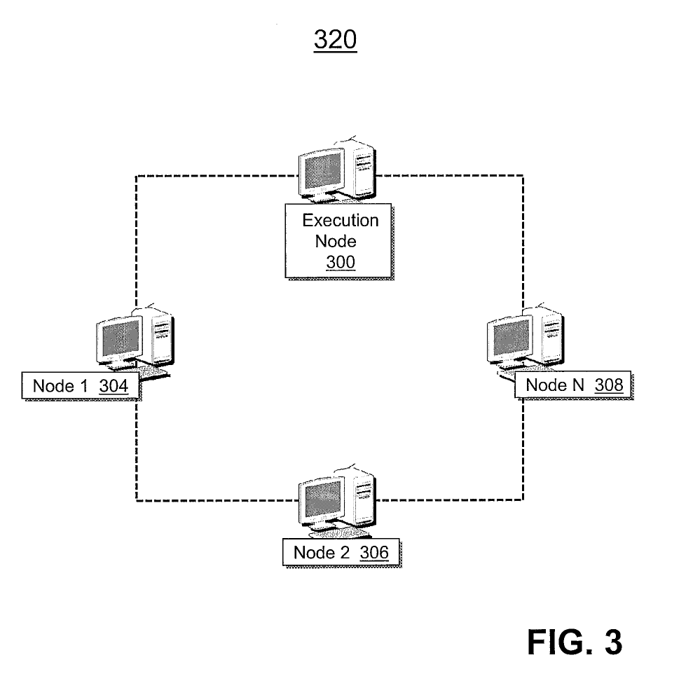

FIG. 3 depicts a cluster environment comprising multiple nodes in which a registry/repository application is executed. Cluster environment 320 comprises execution node 300, node 1 304, node 2 306, and node n 308 (wherein ‘n’ represents an undefined finite number).

Execution node 300, node 1 304, node 2 306, and node n 308 are associated with a cluster environment. In one embodiment, each node within the cluster environment utilizes a registry/repository application. The registry/repository application receives notification that changes have been made to the user-written plug-in code on execution node 300. The registry/repository application reinitializes to create JAVA classes based on the modified JAR files. The JAR utility initiates a notification of the changes to the user-written plug-in code. The changes to the user-written plug-in code are detected by all active nodes (execution node 300, node 1 304, node 2 306, and node n 308) in cluster environment 320. As an alternative approach to notifying each node in a cluster, each node could detect that a change has been made in the database and perform the reload when needed.

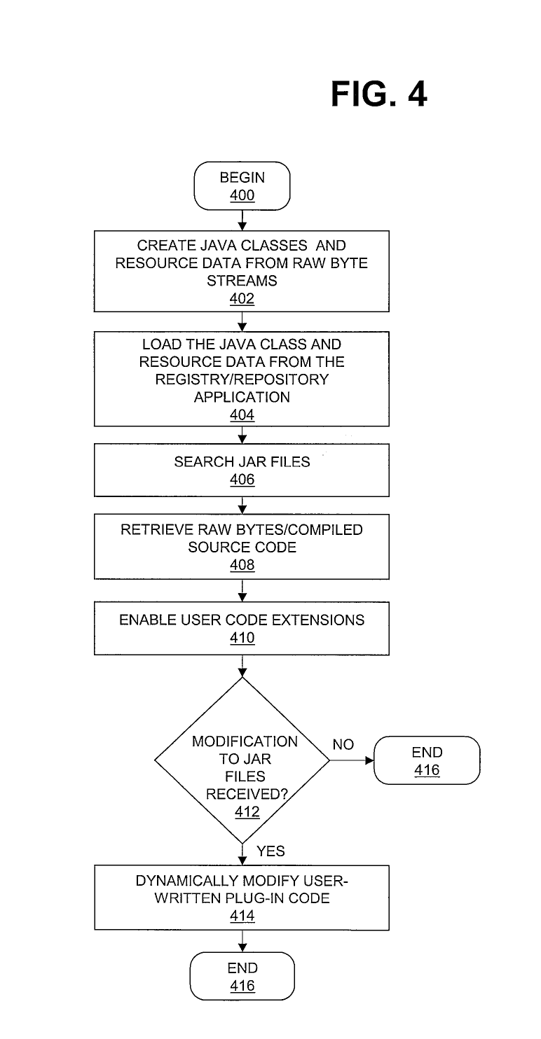

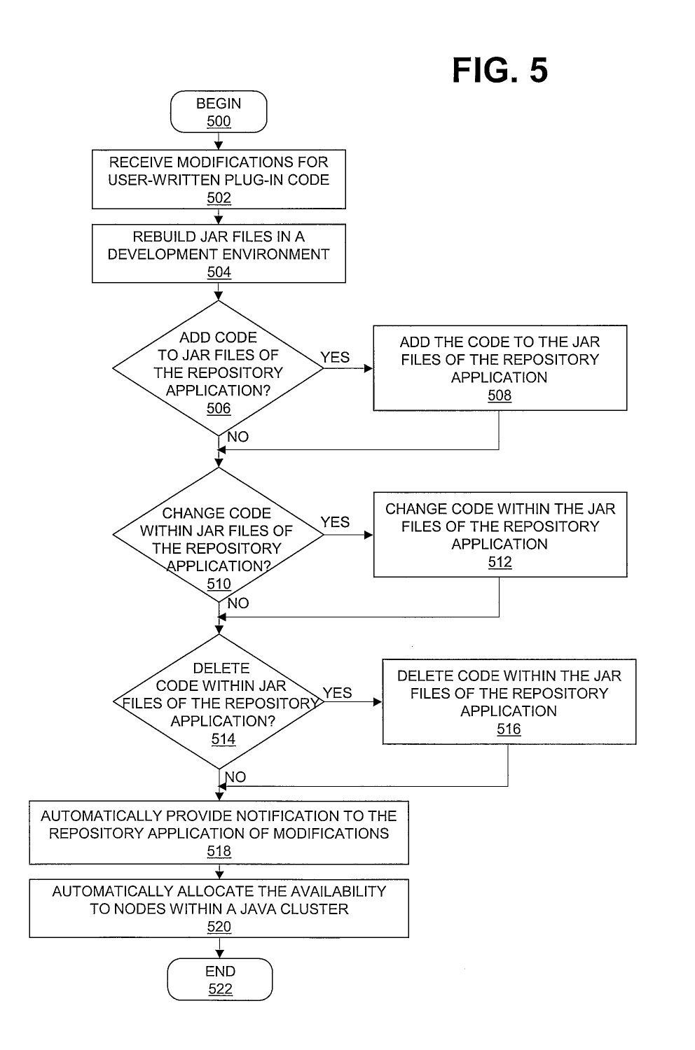

FIGS. 4-5 are flow charts illustrating various methods by which the above processes of the illustrative embodiments are completed. Although the methods illustrated in FIGS. 4-5 may be described with reference to components shown in FIGS. 1-3, it should be understood that this is merely for convenience and alternative components and/or configurations thereof can be employed when implementing the various methods. Key portions of the methods may be completed by JAR utility 140 executing within DPS 100 (FIG. 1) and controlling specific operations on DPS 100, and the methods are thus described from the perspective of both JAR utility 140 and DPS 100.

FIG. 4 describes a process for modifying user-written plug-in code when modifications to the JAR files are received. The process of FIG. 4 begins at initiator block 400 and proceeds to block 402, at which JAVA classes are created from raw-byte streams. At block 404 the JAVA class and resource data is loaded from the registry/repository application. The JAR files are searched for raw-bytes that represent the Java classes and associated resources that comprise the user-written plug-in code, at block 406. At block 408 the raw-bytes/compiled source code is retrieved from the JAR files. User code extensions are enabled at block 410, when the repository application retrieves the compiled source code. A decision is made at block 412 whether modifications to the JAR files were received. If there were no modifications received, the process ends at block 416. If modifications to the JAR files were received, the process continues to block 414. At block 414 the user written plug-in code is dynamically modified. The process ends at block 416.

The process for allocating the availability of the modified JAR files to nodes within the JAVA cluster environment is depicted in FIG. 5. The process of FIG. 5 begins at initiator block 500 and proceeds to block 502, at which modifications for the user-written plug-in code is received. At block 504 the JAR files are rebuilt in a development environment. A decision is made at block 506 whether the modification is to add code to the JAR files of the repository application. If the decision is to add code to the JAR files of the repository application, the process continues to block 508. At block 508, code is added to the JAR files of the repository application. If the decision is not to add code to the repository application, the process continues to block 510.

A decision is made whether to change the code within the JAR files of the repository application, at block 510. If a decision is made to change the code within the JAR files, the process continues to block 512. At block 512 the code within the JAR files of the repository application is changed. If a decision is made not to change the code within the JAR files, the process continues to block 514. A decision is made at block 514 whether to delete code within the JAR files of the repository application. If a decision is made to delete code within the JAR files, the process continues to block 516. At block 516 code within the JAR files of the repository application are deleted. If a decision is made not to delete code within the JAR files of the repository application, the process continues to block 518. Notification of modifications to the registry/repository application is automatically received, at block 518. At block 520 the availability of the modified JAR files are automatically allocated to the nodes executing within the JAVA cluster. The process ends at block 522.

In the flow charts above, one or more of the methods are embodied as a computer program product in a computer readable storage medium or containing computer readable code such that a series of steps are performed when the computer readable code is executed on a computing device. In some implementations, certain steps of the methods are combined, performed simultaneously or in a different order, or perhaps omitted, without deviating from the spirit and scope of the invention. Thus, while the method steps are described and illustrated in a particular sequence, use of a specific sequence of steps is not meant to imply any limitations on the invention. Changes may be made with regards to the sequence of steps without departing from the spirit or scope of the present invention. Use of a particular sequence is therefore, not to be taken in a limiting sense, and the scope of the present invention is defined only by the appended claims.

As will be further appreciated, the processes in embodiments of the present invention may be implemented using any combination of software, firmware or hardware. As a preparatory step to practicing the invention in software, the programming code (whether software or firmware) will typically be stored in one or more machine readable storage mediums such as fixed (hard) drives, diskettes, optical disks, magnetic tape, semiconductor memories such as ROMs, PROMs, etc., thereby making an article of manufacture (or computer program product) in accordance with the invention. The article of manufacture containing the programming code is used by either executing the code directly from the storage device, by copying the code from the storage device into another storage device such as a hard disk, RAM, etc., or by transmitting the code for remote execution using transmission type media such as digital and analog communication links. The methods of the invention may be practiced by combining one or more machine-readable storage devices containing the code according to the present invention with appropriate processing hardware to execute the code contained therein. An apparatus for practicing the invention could be one or more processing devices and storage systems containing or having network access to program(s) coded in accordance with the invention.

Thus, it is important that while an illustrative embodiment of the present invention is described in the context of a fully functional computer (server) system with installed (or executed) software, those skilled in the art will appreciate that the software aspects of an illustrative embodiment of the present invention are capable of being distributed as a computer program product in a variety of forms, and that an illustrative embodiment of the present invention applies equally regardless of the particular type of media used to actually carry out the distribution. By way of example, a non exclusive list of types of media, includes recordable type (tangible) media such as floppy disks, thumb drives, hard disk drives, CD ROMs, DVDs, and transmission type media such as digital and analogue communication links.

While the invention has been described with reference to exemplary embodiments, it will be understood by those skilled in the art that various changes may be made and equivalents may be substituted for elements thereof without departing from the scope of the invention. In addition, many modifications may be made to adapt a particular system, device or component thereof to the teachings of the invention without departing from the essential scope thereof. Therefore, it is intended that the invention not be limited to the particular embodiments disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another.

1. A method comprising:
enabling a class loader of a Java virtual machine to load JAVA class and resource data from within a repository application when the repository application includes a database that stores one or more JAR files whereby the JAR files contain a user-written plug-in code and associated resources;
creating JAVA classes from raw-byte streams, wherein the raw-byte streams represent compiled source code and associated resources;
loading the JAVA class and resource data from the repository application;
searching the JAR files to retrieve one or more raw bytes that represent JAVA classes and associated resources;
enabling user-code extensions when the repository application retrieves the compiled source code from the JAR files;
dynamically modifying the user-written plug-in code when modifications to one or more stored JAR files are received;
when one or more modifications are received for the user-written plug-in code, rebuilding the JAR files in a development environment, wherein the development environment is outside the repository application;
in response to the modifications to the user-written plug-in code completing one or more of:
adding code to the JAR files of the repository application;
changing code within the JAR files of the repository application; and
deleting code within the JAR files of the repository application;
automatically providing a notification to the repository application in response to one or more modifications of the user-written plug-in code; and
automatically allocating the availability of one or more modified JAR files to one or more members executing on one or more nodes within a JAVA cluster.

2. A computer program product comprising:
a computer readable storage medium; and
program code on the computer readable storage medium that when executed by a processor provides the functions of:
enabling a class loader of a Java virtual machine to load JAVA class and resource data from within a repository application when the repository application includes a database that stores one or more JAR files whereby the JAR files contain a user-written plug-in code and associated resources;
creating JAVA classes from raw-byte streams, wherein the raw-byte streams represent compiled source code and associated resources;
loading the JAVA class and resource data from the repository application;
searching the JAR files to retrieve one or more raw bytes that represent JAVA classes and associated resources;
enabling user-code extensions when the repository application retrieves the compiled source code from the JAR files;
dynamically modifying the user-written plug-in code when modifications to one or more stored JAR files are received;
when one or more modifications are received for the user-written plug-in code, rebuilding the JAR files in a development environment, wherein the development environment is outside the repository application;
in response to the modifications to the user-written plug-in code completing one or more of:
adding code to the JAR files of the repository application;
changing code within the JAR files of the repository application; and
deleting code within the JAR files of the repository application;
automatically providing a notification to the repository application in response to one or more modifications of the user-written plug-in code; and
automatically allocating the availability of one or more modified JAR files to one or more members executing on one or more nodes within a JAVA cluster.

3. A computer system comprising:
a processor component;
a utility executing on the processor component and which comprises codes that enables completion of the following functions:
enabling a class loader of a Java virtual machine to load JAVA class and resource data from within a repository application when the repository application includes a database that stores one or more JAR files whereby the JAR files contain a user-written plug-in code and associated resources;
creating JAVA classes from raw-byte streams, wherein the raw-byte streams represent compiled source code and associated resources;
loading the JAVA class and resource data from the repository application;
searching the JAR files to retrieve one or more raw bytes that represent JAVA classes and associated resources;
enabling user-code extensions when the repository application retrieves the compiled source code from the JAR files;
dynamically modifying the user-written plug-in code when modifications to one or more stored JAR files are received;
when one or more modifications are received for the user-written plug-in code, rebuilding the JAR files in a development environment, wherein the development environment is outside the repository application;
in response to the modifications to the user-written plug-in code completing one or more of:
adding code to the JAR files of the repository application;
changing code within the JAR files of the repository application; and
deleting code within the JAR files of the repository application;
automatically providing a notification to the repository application in response to one or more modifications of the user-written plug-in code; and
automatically allocating the availability of one or more modified JAR files to one or more members executing on one or more nodes within a JAVA cluster.
